(19) United States
(12) Patent Application Publication
(10) Pub. No.: US 2009/0113653 A1
(43) Pub. Date: May 7, 2009

(54) Linking support for flat windscreen-wiper blade

(75) Inventor: Jean-Claude Thienard, Gisors (FR)

Correspondence Address: OSHA LIANG L.L.P., TWO HOUSTON CENTER, 909 FANNIN, SUITE 3500, HOUSTON, TX, 77010, US

(73) Assignee: Valeo Systemes d'Essuyage, Le Mesnil-Saint-Denis (FR)

(21) Appl. No.: 11/794,134

(22) PCT Filed: Dec. 16, 2005
(86) PCT No.: PCT/EP05/13591

§ 371 Date: Apr. 15, 2008

(30) Foreign Application Priority Data
Dec. 23, 2004 (FR) 0413795

(51) Int. Cl. B60S 1/40

(52) U.S. Cl. 15/250.32

(57) ABSTRACT

The present invention relates to a linking support 130 of a flat windscreen-wiper blade, designed to be solidly attached to a wiping strip in order to couple it with a drive arm, in particular of a windscreen-wiper device of a motor vehicle.

The invention is characterised in that the linking support 130 comprises two sheet-metal sides 131a, 131b which are connected at the top by at least one sheet-metal portion 132, 133 shared between said sheet-metal sides 131a, 131b, forming a top cross-piece 134, 135, and which are connected at the bottom by at least one pair of sheet-metal portions 136a, 136b, 137a, 137b solidly attached to one another, forming a bottom cross-piece 138, 139, the two sheet-metal portions 136a, 136b, 137a, 137b of the same bottom cross-piece 138, 139 respectively being formed integral with each sheet-metal side 131a, 131b.

The present invention relates to an element designed to be an integral part of the supporting structure of a flat windscreen-wiper blade, in order to provide, in particular, functions of supporting the wiping strip and linking with any suitably shaped drive.

The invention has a particularly advantageous but not exclusive application in the field of windscreen-wiper devices for motor vehicles.

Compared with the straight blades currently used on most vehicles, a flat windscreen-wiper blade has the uniqueness of not having a structure with spreaders. This new generation of windscreen wipers continues to use a flexible wiping strip, but the external frame supporting it is replaced with a flexible structure formed integral with the strip.

Traditionally, the wiping strip and the flexible structure are solidly attached to one another by means of a linking support which also has the function of allowing the corresponding flat windscreen-wiper blade to be coupled with any suitably shaped drive arm, regardless of the chosen drive mechanism. It should be remembered at this point that there are different types of blade arms such as, for example, hook arms, lateral pivoting arms, longitudinal snap-fitting arms, etc. Regardless of the arm used, the linking support must have considerable rigidity in order to guarantee the resistance of the assembly, which is why it is usually made from Zamak (registered trademark).

This type of linking support, however, has the disadvantage of being particularly expensive, mainly due to the intrinsic cost price of the material, which is relatively high, and especially to the very high manufacturing cost inherent in implementing an inevitable moulding process.

To solve this difficulty, it is possible to use a linking support made from sheet metal, which consists diagrammatically of an assembly of a plurality of independent parts, made individually from pressed and/or folded sheets.

However, it emerges in the practice that such a linking support is not always capable of effectively withstanding the twisting and/or shearing forces generated when using a flat windscreen-wiper blade. The composite structure of the linking support is evidently directly responsible for this major weakness.

Also, the technical problem that the present invention aims to solve is to provide a flat windscreen-wiper blade linking support designed to be solidly attached to a wiping strip in order to couple it with a drive arm, in particular of a windscreen-wiper device of a motor vehicle, linking support that would avoid the problems of the state of the art, in particular by providing considerably increased structural rigidity, while guaranteeing a relatively low cost price.

The solution to the technical problem posed consists, according to the present invention, in that the linking support comprises two sheet-metal sides, which are connected at the top by at least one sheet-metal portion shared between said sheet-metal sides, forming a top cross-piece, and which are connected at the bottom by at least one pair of sheet-metal portions, solidly attached to one another, forming a bottom cross-piece, the two sheet-metal portions of the same bottom cross-piece respectively being formed integral with each sheet-metal side.

The invention as thus defined has the advantage of benefiting from extreme rigidity. The one-piece structure of the linking support effectively provides optimum resistance to the twisting and/or shearing forces.

Compared with the moulded parts of the prior art, and even compared with the assemblies of sheet-metal pieces, a linking support according to the invention is actually less expensive to manufacture, since it is made simply by pressing and folding a single sheet of metal, and it does not require the assembly of any additional structural parts.

Another considerable benefit is to be found in the considerable gains obtained in terms of size. As the linking support according to the invention does not have a structurally bottom, it is possible considerably to lower the point of attachment with the drive arm. The height of the assembly can then be optimally minimised. And yet, any considerable improvement of its compactness can be particularly advantageous in the end, both from an aesthetic point of view and in terms of easy integration.

The present invention also relates to the characteristics that appear from the following description, which should be considered in isolation or in any technically feasible combination.

This description, given by way of non-limiting example, aims to provide a clearer understanding of what the invention consists of and how it can be implemented. The description is also made in reference to the appended drawings, wherein:

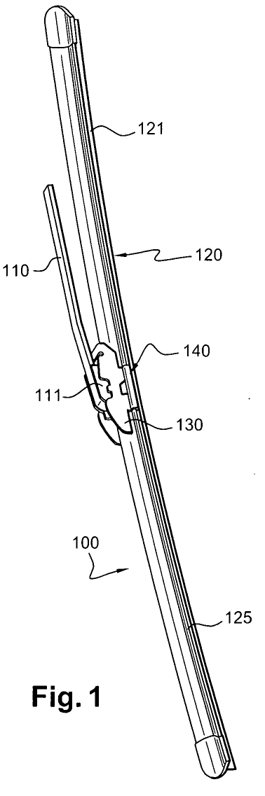

FIG. 1 depicts a flat windscreen-wiper blade mounted on the end of a hook drive arm, said flat windscreen-wiper blade comprising a linking support according to a first embodiment of the invention.

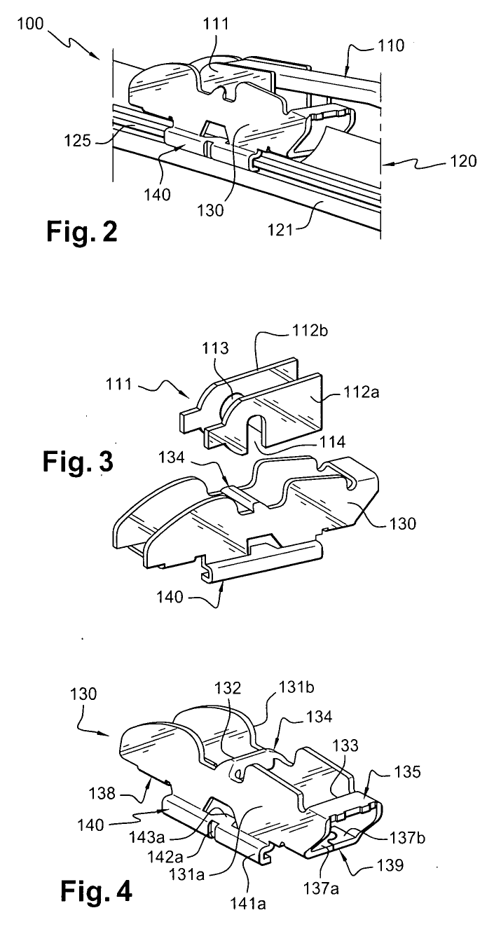

FIG. 2 shows a detail view of the connection area between the flat windscreen-wiper blade and the hook arm of FIG. 1.

FIG. 3 is an exploded view showing the linking support of FIGS. 1 and 2, with its adaptor for a hook arm.

FIG. 4 shows the linking support of FIGS. 1 to 3 in a top rear perspective view.

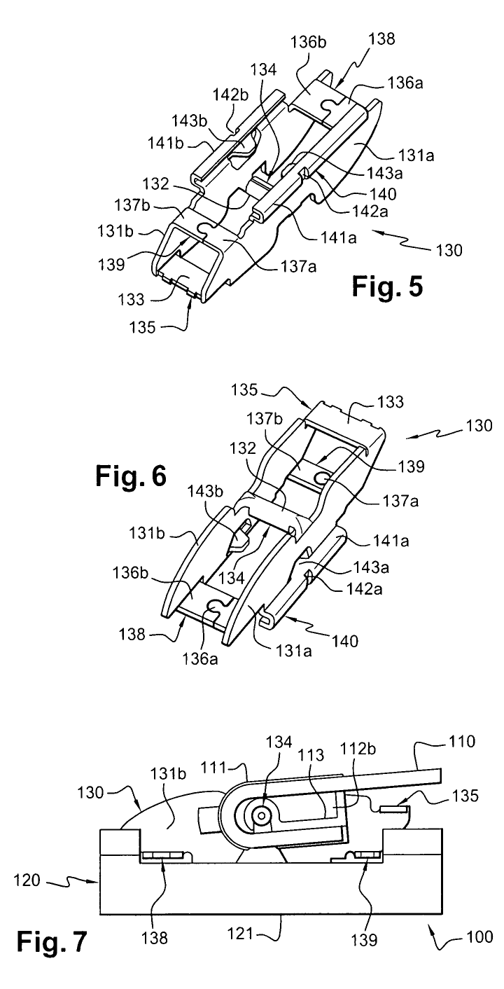

FIG. 5 is a view similar to that of FIG. 4, but in a bottom rear perspective view.

FIG. 6 constitutes a view similar to those of FIGS. 4 and 5, but in a top front perspective view.

FIG. 7 shows a sagittal section view of the assembly of FIG. 2.

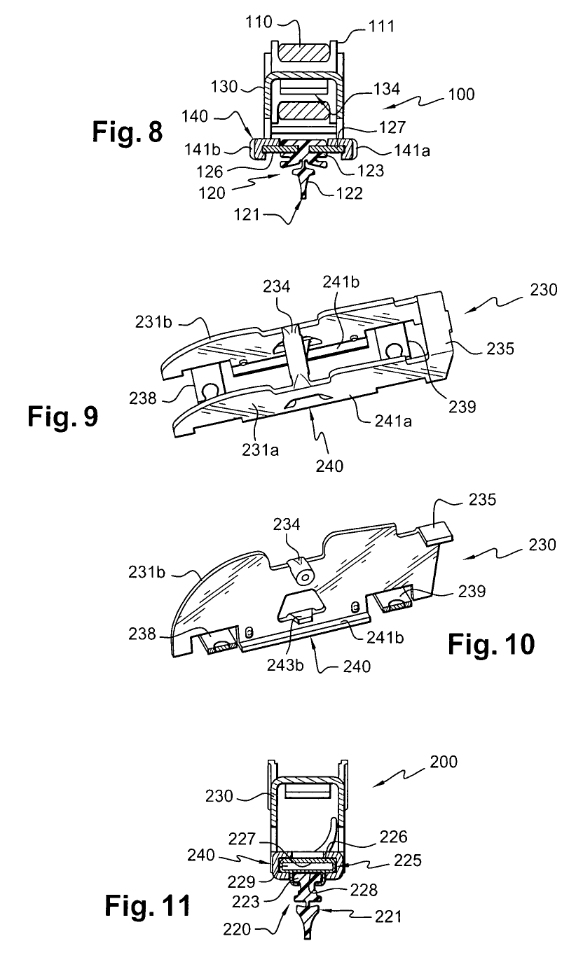

FIG. 8 shows the assembly of FIG. 2 in a cross-section view at the level of the rolled pin.

FIG. 9 depicts, in a top perspective view, a linking support according to a second embodiment of the invention.

FIG. 10 shows a top perspective longitudinal section view of the linking support of FIG. 9.

FIG. 11 is a cross-section view of a flat windscreen-wiper blade equipped with the linking support of FIGS. 9 and 10.

FIG. 12 shows a removable case capable of covering the linking support of FIGS. 9 to 11.

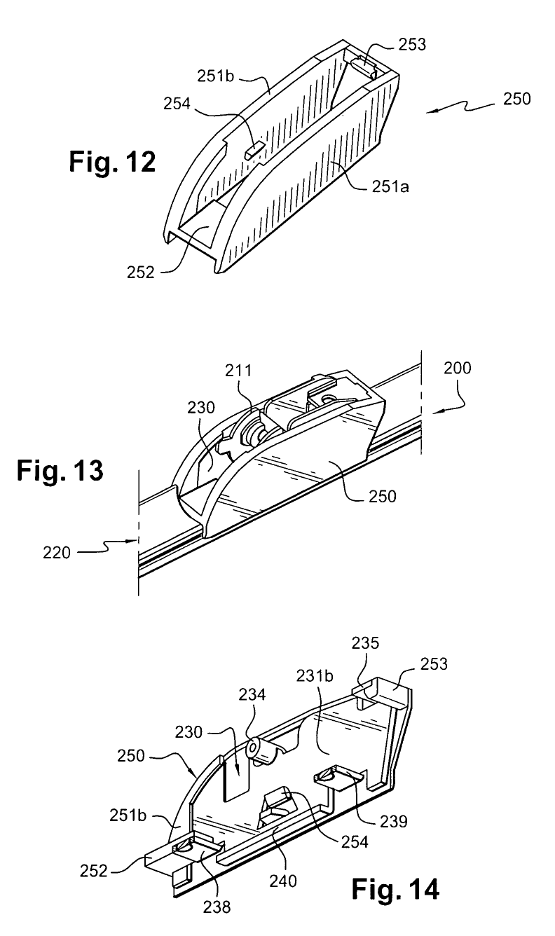

FIG. 13 shows the linking support of FIGS. 9 to 11 covered with the removable case of FIG. 12.

FIG. 14 is a perspective longitudinal section view showing the interlocking between the linking support of FIGS. 9 to 11 and the removable case of FIG. 12.

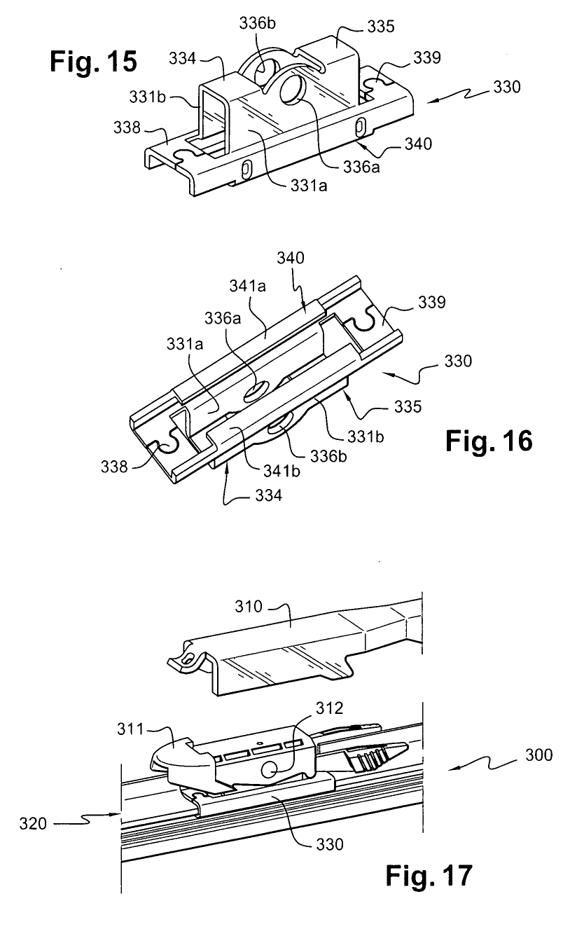

FIG. 15 shows, in a top front perspective view, a linking support according to a third embodiment of the invention.

FIG. 16 is a view similar to that of FIG. 15, but in a bottom perspective view.

FIG. 17 is a top front perspective view of a flat windscreen-wiper blade equipped with the linking support of FIGS. 15 and 16 and of its associated drive arm.

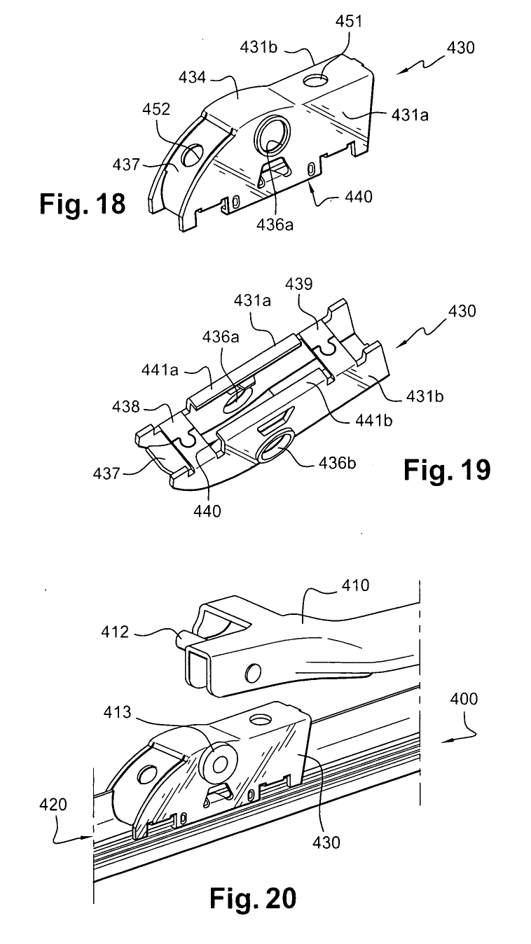

FIG. 18 depicts, in a top front perspective view, a linking support according to a fourth embodiment of the invention.

FIG. 19 is a view similar to that of FIG. 18, but in a bottom perspective view.

FIG. 20 shows a top front perspective view of a flat windscreen-wiper blade equipped with the linking support of FIGS. 18 and 19, and of its associated drive arm.

For reasons of clarity, the same references are used to designate identical elements. Similarly, only the elements which are essential for understanding the invention are shown, without being drawn to scale and in diagrammatic manner.

FIG. 1 depicts a flat windscreen-wiper blade 100 mounted on the end of a drive arm 110 of a windscreen-wiper device of a motor vehicle. This flat windscreen-wiper blade 100 consists diagrammatically of a wiping strip 120 on which a linking support is mounted 130, which in this case conforms to a first embodiment of the invention.

As can be seen a little more clearly in FIG. 2, it is actually a first-generation flat windscreen-wiper blade 100, in the sense that the wiping strip 120 is presented in the form of a flexible elastomer profile 121, formed integral with a flexible structure 125 supporting it.

The flexible profile 121 consists mainly of a lip 122 designed to cooperate directly by sliding contact with a surface to be wiped, and of a heel 123 forming an interface between said lip 122 and the flexible structure 125 (FIG. 8).

As for the flexible structure 125, it consists of two elastically deformable metal tongues 126, 127 integrated longitudinally and respectively on each surface of the flexible profile 121 (FIG. 8). Each tongue 126, 127, commonly called a spine, is responsible for distributing the load pressure evenly across the length of the wiping strip 120 with a view to optimising the wiping quality.

Traditionally, the flexible profile 121 and the two spines 126, 127 are kept solidly attached by means of the linking support 130, which also has the function of providing a connection between the flat windscreen-wiper blade 100 and the associated drive arm 110.

In this specific embodiment, provided only by way of example, the drive arm 110 in question consists of a hook arm. This means that it is normally coupled with the linking support 130 by means of an adaptor 111 that can be clearly seen in FIG. 3. Specifically, this is an intermediate articulation part which, on the one hand, is rigidly fixed to the end of the drive arm 110 and, on the other hand, is mounted mobile so as to pivot in relation to the linking support 130.

According to FIGS. 3 and 7, the adaptor 111 is presented specifically in the form of two flanges 112a, 112b symmetrically connected to one another by a central part 113 with a shape adapted to fit inside the hook arranged on the end of the drive arm 110. It can also be seen that a lateral groove 114 is arranged transversally through the adaptor 111, in order to be able to receive a rotating pin 134 solidly attached to the linking support 130. Its keyhole-shaped cross-section (FIG. 3) is sized so as to allow the adaptor 111 to snap-fit around the pin 134 in question. The assembly is arranged so that, after interlocking by elastic deformation, the adaptor 111 is capable of pivoting longitudinally within the linking support 130 (FIGS. 2 and 7).

FIGS. 4 to 6 show the linking support 130 of this first embodiment from various angles.

According to the aim of the present invention, this linking support 130 is equipped with two sheet-metal sides 131a, 131b which are connected first at the top by two sheet-metal portions 132, 133 shared between said sheet-metal sides 131a, 131b, forming two top cross-pieces 134, 135. The two sheet-metal sides 131a, 131b of the linking support 130 are also connected at the bottom, but in this case by two pairs of sheet-metal portions 136a, 136b, 137a, 137b solidly attached to one another, forming two bottom cross-pieces 138, 139. The assembly is furthermore arranged so that the two sheet-metal portions 136a, 136b, 137a, 137b of each bottom cross-piece 138, 139 are respectively formed integral with the sheet metal of each side 131a, 131b.

In this example of an embodiment, the linking support 130 when complete therefore has a central top cross-piece 134, a rear top cross-piece 135, a front bottom cross-piece 138 and a rear bottom cross-piece 139.

As can be seen in FIGS. 5 to 7, the various top 134, 135 and bottom cross-pieces 138, 139 are longitudinally offset in relation to one another. This special feature makes it possible to free access to the bottom cross-pieces 138, 139 from the top of the linking support 130. The aim is essentially to facilitate the operations of solid attachment of the sheet-metal portions 136a, 136b, 137a, 137b that make up the bottom cross-pieces 138, 139. For this purpose, it is particularly advantageous for none of the top cross-pieces 134, 135 to be located directly above any of the bottom cross-pieces 138, 139.

The same figures furthrmore show that, also in an entirely advantageous fashion, the top cross-pieces 134, 135 and the bottom cross-pieces 138, 139 are alternatingly distributed respectively along the top and bottom parts of the linking support 130. It should be noted that this characteristic only makes sense in the case of the various cross-pieces 134, 135, 138, 139 being longitudinally offset as described above.

According to one special feature of the invention, the two sheet-metal portions 136a, 136b, 137a, 137b of each bottom cross-piece 138, 139 are solidly attached to one another in the same plane. This characteristic ensures a certain continuity of shapes in the bottom cross-pieces 138, 139, in a plane that is substantially perpendicular to the sagittal plane of the linking support 130.

In a particularly advantageous manner, the two sheet-metal portions 136a, 136b, 137a, 137b of each bottom cross-piece 138, 139 are solidly attached to one another by interlocking substantially complementary shapes, in a direction substantially perpendicular to the direction in which said sheet-metal portions 136a, 136b, 137a, 137b are designed to extend once said bottom cross-piece 138, 139 is formed.

The parts of the sheet-metal portions 136a, 136b, 137a, 137b designed to interlock with one another to form each bottom cross-piece 138, 139 are substantially dovetailed.

As can be seen in FIGS. 3 to 7, the linking support 130 is equipped with a top cross-piece 134 which is folded transversally with a tubular profile to constitute a rolled pin. Furthermore, this rolled pin can be coupled in rotation with an adaptor 111 so as to be solidly attached in a removable manner to the end of the drive arm 110, in this case a hook arm. It is specified that the fact that the top cross-piece 134 is folded transversally with a tubular profile simply means that the rolled pin extends perpendicularly between the sides 131a, 131b of the linking support 130.

According to another special feature of the invention, the linking support 130 is equipped with means for fixing 140 the wiping strip 120.

As already mentioned above, the wiping strip 120 consists of a flexible profile 121 formed integral with a flexible structure 125 which supports it. Having said that, the fixing means 140 in this case are equipped with two pre-shaped sheet-metal portions 141a, 141b, which are respectively formed integral with each sheet-metal side 131a, 131b. These pre-shaped portions 141a, 141b are capable of interlocking transversally by force with two portions 126, 127 of the flexible structure 125 of the wiping strip 120, which are positioned substantially opposite one another on each of the surfaces of said wiping strip 120. The pre-shaped portions 141a, 141b and the portions 126, 127 with a flexible structure 125 also have substantially complementary shapes, in order to guarantee that the linking support 130 and the wiping strip 120 are fixed together by forced interlocking.

In the first embodiment, shown in FIGS. 1 to 7, each pre-shaped sheet-metal portion 141a, 141b of the fixing means 140 consists of a longitudinal U-shaped rail, made directly by folding the bottom part of the corresponding side 131a, 131b. According to FIG. 8, each U-shaped rail also has an inner section which is slightly smaller than that of the longitudinal edge of the corresponding elastically deformable spine 126, 127, so as to guarantee the reliability of the forced interlocking.

Although the fixing means 140 as described above are a priori sufficient to guarantee that the wiping strip 120 is supported and immobilised with regard to the linking support 130, an indentation 142a, 142b is made transversally at the middle of each U-shaped rail in order to reinforce the longitudinal stop between the two elements in question (FIGS. 2 to 6).

Furthermore, with the aim of improving the pressure exerted by the fixing means 140 on the top part of the spines 126, 127, and thus to avoid any transversal bending problems, two tongues 143a, 143b are made directly from the sheet metal of the sides 131a, 131b. In order to fulfil their support surface functions, the sheet-metal tongues 143a, 143b are simply folded at right angles towards the inside of the linking support 130 (FIGS. 2 to 6).

FIGS. 9 and 10 depict a linking support 230 according to a second embodiment of the invention. This differs from the first embodiment described previously essentially as regards the fixing means 240 used for attaching to the wiping strip 220. This difference results mainly from the fact that the linking support 230 in this case is designed to be integrated with the bearing structure of a so-called new-generation flat windscreen-wiper blade 200.

According to FIG. 11, such a flat windscreen-wiper blade 200 always consists diagrammatically of a wiping strip 220 on which a linking support 230 is mounted. The wiping strip 220 also always consists of a flexible elastomer profile 221 combined with a flexible structure 225.

However, in this case, the presentation of the flexible structure 225 is different to the same element in the first embodiment, since it consists, on the one hand, of a plastic frame 226 in which a housing 227 and a support rail 228 are longitudinally arranged and, on the other hand, an elastically deformable metal spine 229, placed inside the housing 227. The assembly is arranged so that the heel 223 of the flexible profile 221 can be inserted in the support rail 228.

As in the first embodiment, the linking support 230 comprises two sides 231a, 231b which are connected at the top by two top cross-pieces 234, 235, and at the bottom by two bottom cross-pieces 238, 239. The two sides 231a, 231b and the top cross-pieces 234, 235 are made from the same pressed and folded sheet of metal. As for the bottom cross-pieces 238, 239, they are each made by solidly attaching two sheet-metal portions respectively formed integral with each sheet-metal side 231a, 231b.

In this second embodiment of the invention, the fixing means 240 are equipped with two pre-shaped sheet-metal portions 241a, 241b, respectively formed integral with each sheet-metal side 231a, 231b. These pre-shaped portions 241a, 241b are characterised here in that they are capable of pinning two flexible structure portions 225, positioned substantially opposite one another on each surface of the wiping strip 220, against the two bottom cross-pieces 238, 239.

According to another special feature of the invention, which can be clearly seen in FIGS. 12 to 14, the linking support 230 is capable of cooperating by interlocking with an external removable case 250.

This case 250, made here from a thermoplastic material, fulfils a first purely aesthetic function. This consists, in fact, of concealing the pressed and/or folded sheet-metal structure which is not, indeed, of great promotional value.

A second function can consist, furthermore, of locking the associated drive arm in relation to the linking, support 230.

As can be seen in FIG. 12, the case 250 consists diagrammatically of two lateral flanges 251a, 251b which are transversally connected by a front bottom cross-piece 252, and a rear top cross-piece 253. It also comprises two projecting elements 254 arranged opposite each other on the respective inner surfaces of the lateral flanges 251a, 251b.

The operation of interlocking the case 250 starts by engaging its rear top cross-piece 253 under the rear top cross-piece 235 of the linking support 230 (FIG. 14). The front part of the case 250 is then folded until its front bottom cross-piece comes to a stop against the front bottom cross-piece 238 (FIG. 14). At the same time, the projecting elements 254 of the case 250 are snap-fitted in the sides 231a, 231b of the linking support 230 (FIG. 14), thus locking the interlocking in its final form shown in FIG. 13.

FIGS. 15 and 16 depict a linking support 330 according to a third embodiment of the invention.

In a similar manner to the first two embodiments, the linking support 330 comprises two sides 331a, 331b which are connected at the top by two top cross-pieces 334, 335, and at the bottom by two bottom cross-pieces 338, 339. The two sides 331a, 331b and the top cross-pieces 334, 335 are made from the same pressed and folded sheet of metal. As for the bottom cross-pieces 338, 339, they are each made by solidly attaching two sheet-metal portions respectively formed integral with each sheet-metal side 331a, 331b.

In this third embodiment of the invention, the fixing means 340 are structurally identical to those of the second embodiment. For this reason, they will not be described further here. It is simply pointed out that the two pre-shaped sheet-metal portions used in this case have reference numbers 341a, 341b.

However, according to a special feature of this third embodiment of the invention, the linking support 330 is equipped with two bores 336a, 336b, arranged opposite each other through each side 331a, 331b. According to FIG. 17, the purpose of these two transversal bores 336a, 336b is to support a rotating pin 312 of a pivoting connector 311, which can be solidly attached in a removable fashion to the end of a drive arm, in this case a longitudinal snap-fitting drive arm.

Since the pivoting connector 311, the longitudinal snap-fitting arm 310 and the connection principle are well known, they will not be described further here.

As for FIGS. 18 and 19, they depict a linking support 430 according to a fourth embodiment of the invention.

They therefore show a linking support 430 comprising two sides 431a, 431b which are connected at the top by a single top cross-piece 434, and at the bottom by two bottom cross-pieces 438, 439. The two sides 431a, 431b and the top cross-piece 434 are made from the same pressed and folded sheet of metal. As for the bottom cross-pieces 438, 439, they are each made by solidly attaching two sheet-metal portions respectively formed integral with each sheet-metal side 431a, 431b.

In this fourth embodiment of the invention, the fixing means 440 are structurally identical to those of the second and third embodiments. For this reason, they will not be described further here. It is simply pointed out that the two pre-shaped sheet-metal portions used in this case have reference numbers 441a, 441b.

However, according to a special feature of this fourth embodiment of the invention, the linking support 430 is equipped with two bores 436a, 436b, arranged opposite each other through each side 431a, 431b. According to FIG. 20, these two transversal bores 436a, 436b have the function of supporting a tubular shaft 413 which can accommodate a rotating pin 412 arranged transversally at the end of a drive arm 410, in this case a lateral pivoting arm. Since the tubular shaft 413, the lateral pivoting arm 410 and the connection principle are well known, they will not be described further here.

According to another special feature of this fourth embodiment of the invention, the linking support 430 is equipped with a top cross-piece 434 comprising a lateral sheet-metal portion 437 which is free from the sides 431a, 431b. This lateral portion can also be folded substantially following the top contour of the linking support 430 in order at least partially to conceal the gap between the sides 431a, 431b.

The invention also relates to any flat windscreen-wiper blade equipped with any linking support such as previously described.

Evidently, the invention also relates to any motor vehicle equipped with at least one such flat windscreen-wiper blade.

1. A linking support of a flat windscreen-wiper blade, designed to be solidly attached to a wiping strip in order to couple it with a drive arm, in particular of a windscreen-wiper device of a motor vehicle, wherein it comprises two sheet-metal sides which are connected at the top by at least one portion of sheet metal shared between said sheet-metal sides, forming a top cross-piece, and which are connected at the bottom by at least one pair of sheet-metal portions solidly attached to one another, forming a bottom cross-piece, the two sheet-metal portions of the same bottom cross-piece respectively being formed integral with each sheet-metal side.

2. The linking support according to claim 1, wherein the top cross-pieces and the bottom cross-pieces are longitudinally offset in relation to one another.

3. The linking support according to claim 2, wherein the top cross-pieces and the bottom cross-pieces are alternatingly distributed respectively along the top and bottom parts of said linking support.

4. The linking support according to claim 1, wherein the two sheet-metal portions of the same bottom cross-piece are solidly attached to one another in the same plane.

5. The linking support according to claim 1, wherein the two sheet-metal portions of the same bottom cross-piece are solidly attached to one another by interlocking substantially complementary shapes, in a direction substantially perpendicular to the direction in which said sheet-metal portions are designed to extend once said bottom cross-piece is formed.

6. The linking support according to claim 5, wherein the parts of the sheet-metal portions designed to interlock with one another to form each bottom cross-piece are substantially dovetailed.

7. The linking support according to claim 1, wherein it comprises at least one top cross-piece equipped with at least one lateral sheet-metal portion which is free from the sheet-metal sides, but which can be folded substantially following the top contour of the linking support in order at least partially to conceal the gap between said sheet-metal sides.

8. The linking support according to claim 1, wherein it comprises a top cross-piece folded transversally with a tubular profile to constitute a rolled pin which can be coupled in rotation with an adaptor so as to be solidly attached in a removable manner to the end of the drive arm.

9. The linking support according to claim 1, wherein it comprises two bores arranged opposite each other through each side, and which are capable of supporting a rotating pin of a pivoting connector which can be solidly attached in a removable manner to the end of a drive arm.

10. The linking support according to claim 1, wherein it comprises two bores arranged opposite each other through each side, and which are capable of supporting a tubular shaft which can accommodate a rotating pin arranged transversally at the end of a drive arm.

11. The linking support according to claim 1, wherein it comprises means of fixing the wiping strip.

12. The linking support according to claim 11, wherein the wiping strip consisting of a flexible profile formed integral with a flexible structure which supports it, the fixing means comprise at least two pre-shaped sheet-metal portions respectively formed integral with each sheet-metal side, and which are capable of transversally interlocking by force with two portions of the flexible structure with substantially complementary shapes, positioned substantially opposite each other on each of the surfaces of the wiping strip.

13. The linking support according to claim 11, wherein the wiping strip consisting of a flexible profile formed integral with a flexible structure which supports it, the fixing means (240) comprise at least two pre-shaped sheet-metal portions respectively formed integral with each sheet-metal side, and which are capable of pinning two portions of the flexible structure (225), which are positioned substantially opposite each other on each of the surfaces of the wiping strip, against at least one bottom cross-piece.

14. The linking support according to claim 1, wherein it is capable of cooperating by interlocking with an external removable case.

15. A linking windscreen-wiper blade, comprising a linking support according to claim 1.

16. (canceled)
